(19) United States
(12) Patent Application Publication
(10) Pub. No.: US 2017/0240341 A1
(43) Pub. Date: Aug. 24, 2017

(54) CLAW SKIP MECHANISM WITH LEVEL ADJUSTMENT

(71) Applicant: SAHSAN MAKINA KALIP ELEKTRIK VE ELEKTRONIK SANAYI VE TICARET LIMITED SIRKET, Kagithane, Istanbul (TR)

(72) Inventor: Atilla TEZOL, Istanbul (TR)

(73) Assignee: SAHSAN MAKINA KALIP ELEKTRIK VE ELEKTRONIK SANAYI VE TICARET LIMITED SIRKETI, Kagithane, Istanbul (TR)

(21) Appl. No.: 15/515,740

(22) PCT Filed: Jan. 19, 2016
(86) PCT No.: PCT/TR2016/000011

§ 371 Date: Mar. 30, 2017

(30) Foreign Application Priority Data
Jul. 15, 2015 (TR) 2015/08857

(51) Int. Cl. B65D 83/00; B05C 17/005; B05C 17/01; B65D 47/06; A47G 19/32

(52) U.S. Cl. CPC B65D 83/0022; B65D 47/06; A47G 19/32; B05C 17/012; B05C 17/00576

(57) ABSTRACT

Claw-skip mechanism with level adjustment enables products to be dispensed in tube form includes at least one stem within package body; sequential claws on stem; button enabling to push stem towards lid at adjustable amounts; at least one pusher moves towards lid together with stem as button is pressed pushing product towards lid opening; gasket providing pusher movement within package body without leaving residue; elastic extensions provide pusher to grab one-or-more claws and move, when stem moves towards lid providing pusher to skip one-or-more claws by stretching outwards when stem returns to initial position; at least two-levels and one counter-level positioned across each other on lid and base-lid; level-steps enabling formation of distances between level and counter-level as button or base-lid is turned; amount adjust to be dispensed from package opening to adjustable distance between level and counter-level; adjustment markers enabling levels to the button or base-lid for level adjustment.

The present invention relates to claw skip mechanism with level adjustment that enables the products such as ketchup, mayonnaise, honey, toothpaste, hair dye, butter etc. to be dispensed at the desired dose from the presentation containers in tube etc. form.

Since the viscosity values of the products such as honey, ketchup, mayonnaise, toothpaste, hair dye, cream are high; these products stick onto the inner surfaces of the containers they are filled in and leave residues on such containers. A portion of the mentioned products which leave residues within the packages is wasted this way and is thrown away together with the package. In the state of the art, the products in liquid or cream form are presented to the consumers in packages such as elastic bottles, tubes, containers with spouts (pumps). There is no mechanism in the mentioned packages that enables the products in liquid and cream form to be dispensed completely out of the package (without any residues, remnants). Moreover, the user is required to apply some degree of squeezing pressure on the package body in order to take the product out of the packages such as elastic bottles and tubes. This causes deformation of the current packages by time. In addition, dose adjustment is not possible in the current packages. When elastic bottles are squeezed, the more the volume of the product close to the neck of the package, the more product is dispensed out of the package. The same problem occurs also in the packages in the form of tubes.

In the state of the art, there are some mechanisms that provide dispensing of the product out of the package:

In the state of the art; there are containers with spouts (pumps) mentioned in the documents with publication no US2007075096, namely “Blister pump dispenser”, with publication no US2001052528, namely “Fluid dispenser”, and with publication no CN203388768, namely “Soap liquid bottle”. Containers with spouts (pumps) are commonly used as liquid soap dispensers. The pumps in the shape of a spout are generally positioned at the upper section of the container body. The user pushes down the mentioned pumps several times and causes the product to be dispensed out of the container. The mentioned spout pumps pull the fluid or semi-fluid products out of the container by means of a tube extending into the body of the package. However, when the product reduces in these packages, the products remaining at the section where the tube does not extend into cannot be pulled out by the spout pump. This causes quite a large volume of the products to be wasted. In order to overcome this, the user dismantles the spout pump and tries to reach the product within the package

In the state of the art, there is a rotating (threaded) product dispensing mechanism used in “stick” glues and lipstick packages. The documents with publication no U.S. Pat. No. 5,733,058, namely Dispensing container for a compact product, and with publication no U.S. Pat. No. 2,818,167, namely Holder for stick type medicators, cosmetics and toilet preparations can be given as the examples to the rotating (threaded) product dispensing mechanism. In the rotating (threaded) product dispensing mechanisms; there is a stem with screw pitch in the package. This stem is generally connected to a finger-wheel at the bottom of the package. The user turns this finger-wheel and provides the rotation of the stem. As the stem with screw pitch rotates, the pusher and/or the product moving by the screw pitch is dispensed out of the package. In order to get the product out of the packages with such mechanisms, the user is required to turn the finger-wheel constantly. This method is convenient for the products such as lipstick and stick glue which are used by spreading, where some amount of product to be dispensed out of the package shall be sufficient.

As an example; the products such as honey, mayonnaise, ketchup are consumed by dispensing some amount on the plate, bread or food. Likewise, the cosmetics such as creams, foundations are used by dispensing some amount on the skin. Use of a package with rotating (threaded) mechanism for the mentioned products is not convenient. It is not possible to dispense sufficient amount of product (such as honey, mayonnaise, ketchup, cream) from the packages with rotating (threaded) mechanisms

The present invention which relates to claw skip mechanism with level adjustment that enables the products such as ketchup, mayonnaise, honey, toothpaste, hair dye, butter etc. to be dispensed at the desired dose from the presentation containers in tube etc. form, completely overcomes the above mentioned disadvantages and it is characterized by:
Ability to dispense sufficient amount of product from the package by a single move (pressing the package button only once);
Adjustability of the product amount to be dispensed;
Availability of at least one pusher which moves by skipping the claw or the claws on the stem each time the package button is pressed
Availability of at least one gasket around the pusher;
Complete dispensing of the products in cream or liquid form, out of the package (without any residues and wastes), thanks to the pusher with gasket ;
Adjustability of the extent of the movement of the pusher with gasket, thanks to the level adjustment;
Adjustability of the amount of the product to be dispensed out of the package, thanks to the level adjustment;
Ability to lock the package button thanks to the level adjustment; thus prevention of involuntary dispensing of the product out of the package;
Easy to use, practical, adjustable and economic features of the package with the claw skip mechanism with level adjustment.

In the mentioned claw skip mechanism, the pusher with gasket moves on a stem having sequential claws. Each claw has a shape of a triangle, cone, pyramid or similar shape. The wide bases of the claws positioned sequentially along the stem face the opening of the package. The claws, as the case may be, can also be positioned sequentially along the stem where their bases face the package button. In this position, the claw skip mechanism operates with the reverse direction motion

In the base section of the pusher, there are elastic extensions (flexible outwards) which enable the grab and skip of the claws. The mentioned elastic extensions grab the narrow parts of the claws with triangular, conical, pyramid etc. shapes and stretch at the wide sections.

The stem is mounted on the package button. There is a lid on one end of the package in tube form and a button on the other end.

When the user presses the package button, the stem with claw moves towards the package lid.

As the stem moves, the pusher grabbing a claw also moves towards the lid by the help of the elastic extensions. The pusher moving towards the lid also pushes the product in the package towards the lid. This way, a portion of the product is provided to be dispensed out of the opening of the package.

When the user leaves the button, the button and the stem returns to the previous position. As the stem with claw returns, the wide sections of the claws stretch the elastic extensions of the pusher outwards. When the elastic extensions stretch outwards, the pushers cannot grab the claws (thereby the stem) moving backward. As a result, the pusher remains in its position despite the movement of the stem. As the stem continues to move, the elastic extensions stretching outwards skip to the next claw. The elastic extensions skipping to the next claw grab the narrow section of such claw.

When the user presses the button, the button and the stem moves backwards to the extent of the forward movement they had made. The movement of the pusher is based on the movement of the stem. As based on the amount of the forward movement of the stem, the pusher also moves forward to the same extent. This way, the pusher can skip one or more claws on the stem as based on the backward movement (thereby forward movement) of the stem.

The pusher makes a non-return forward movement in each use. By this movement, the pusher can follow up the product in the package. Accordingly, air is prevented from entering the package in place of the product dispensed out of the package. This way, the product in the package is prevented from contacting air and is kept as fresh for longer periods.

The movement distance of the button (pressing) can be adjusted by the level adjustment. In this case, the movement distance of the stem can also be adjusted together with the button. As mentioned above, the adjustment of the movement distance of the stem also means the adjustment of the movement distance of the pusher. This way, the dose of the product to be dispensed from the package can be adjusted.

The level adjustment is performed by the button and the levels on the base lid across the button. The distance between the levels positioned reciprocally determines the pressing distance of the button. The positions of the level steps according to each other can be changed by moving the button and/or base lid. This way, the movement distance of the button, stem and also the pusher can be adjusted. When there is no gap between the button and the levels on the base lid, naturally, the button cannot be pressed forward. In this case, the button is locked. Accordingly, involuntary product flow from the package is prevented, when not in use.

When the button or the base lid is rotated, the positions of the levels to each other are changed. In this case, there is a gap between the levels. The gap between the levels determines the distance of pressing the button. The number of levels and the positioning combinations to each other provide the adjustment of different gap distances.

The user benefits from the adjustment marks in order to understand the locations of the levels when turning the button or the base lid. When the button or the base lid is turned, the adjustment marks exhibit a minor resistance at each level. This way, the user understands that a level is skipped. The level marks can be indicated as visuals on the package body and/or external surface of the button and/or base lid.

The present invention is explained in detail through sampling with the attached drawings; such drawings are as;

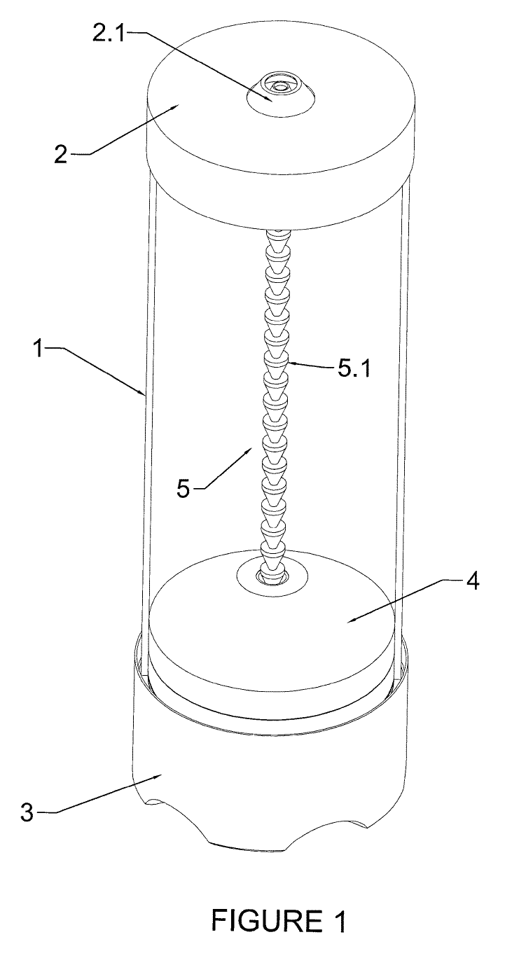

FIG. 1 is the general view of the package with claw skip mechanism with level adjustment in which the pusher is in the start position.

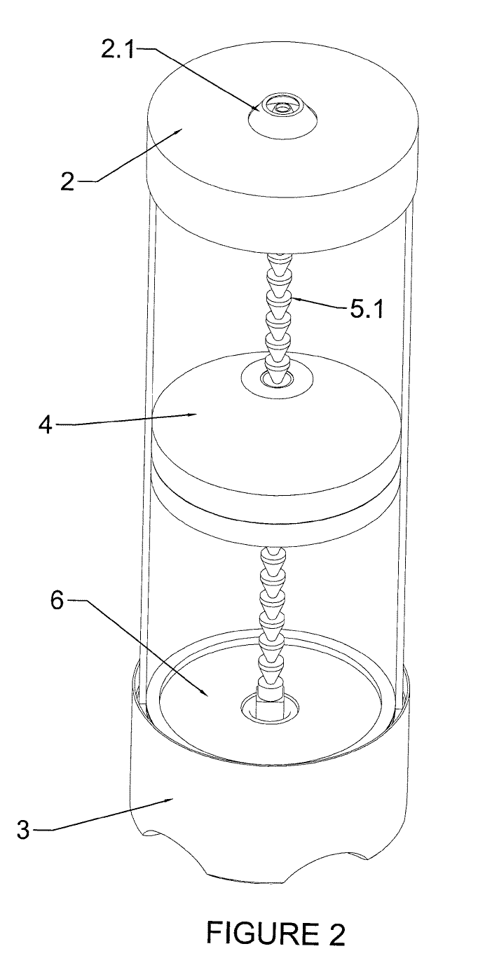

FIG. 2 is the general view of the package with claw skip mechanism with level adjustment in which the pusher is in the forward position.

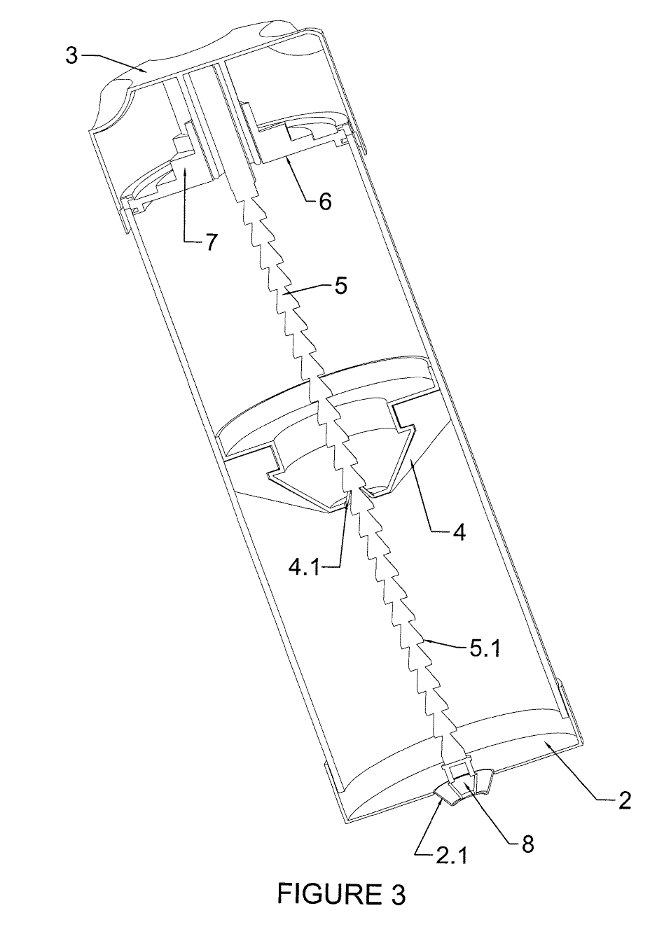

FIG. 3 is the vertical mid-cross sectional view of the package with claw skip mechanism with level adjustment.

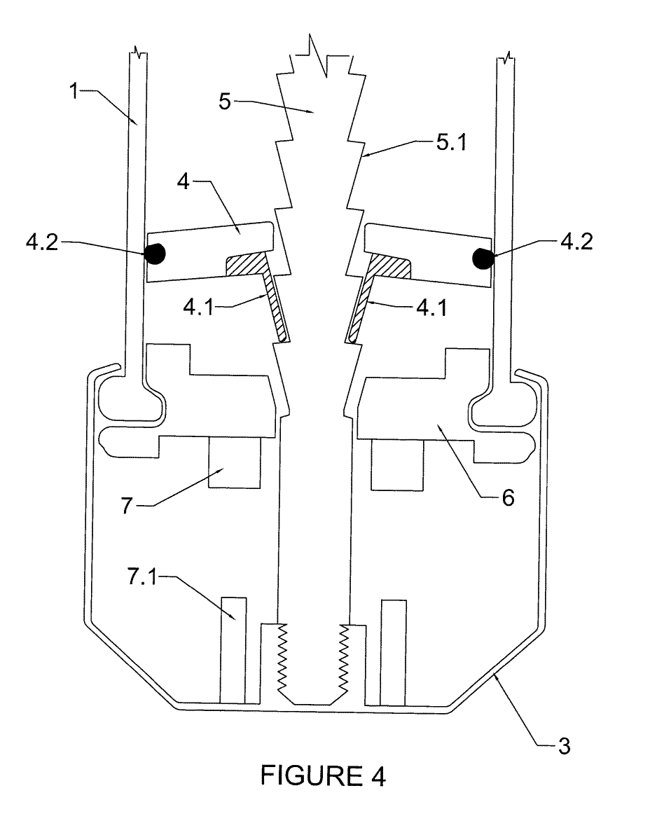

FIG. 4 is the general vies of the claw skip mechanism with level adjustment.

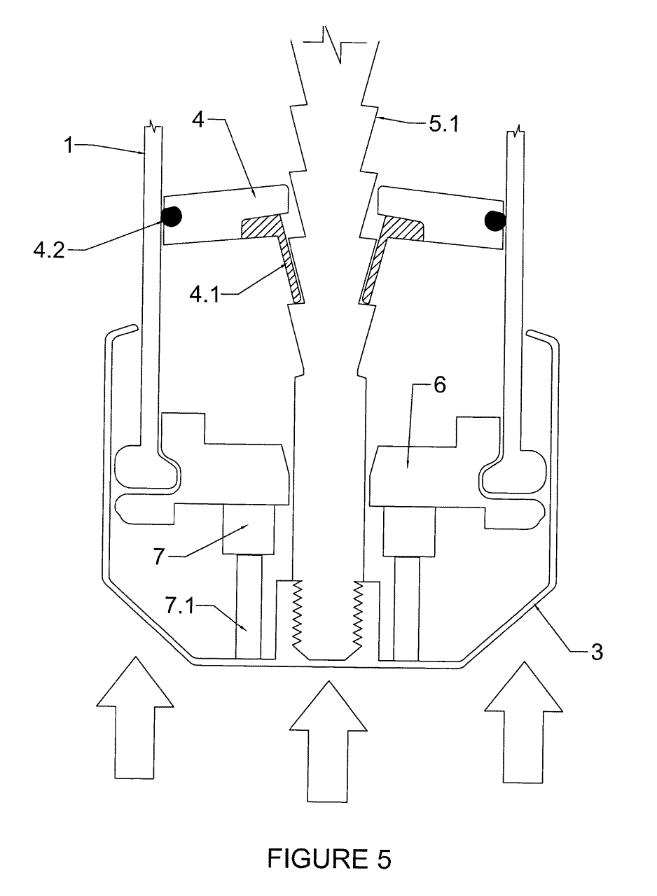

FIG. 5 is the view of the claw skip mechanism with level adjustment when the button is pressed and the pusher is moved forward.

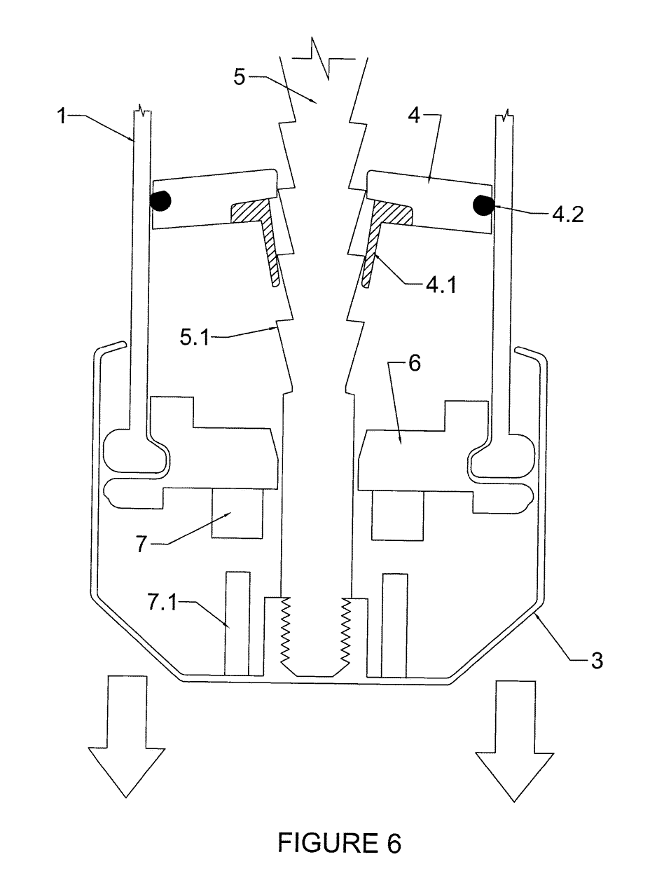

FIG. 6 is the view of the claw skip mechanism with level adjustment when the button and the stem returns and the elastic extensions of the pusher are stretched outwards on the claw.

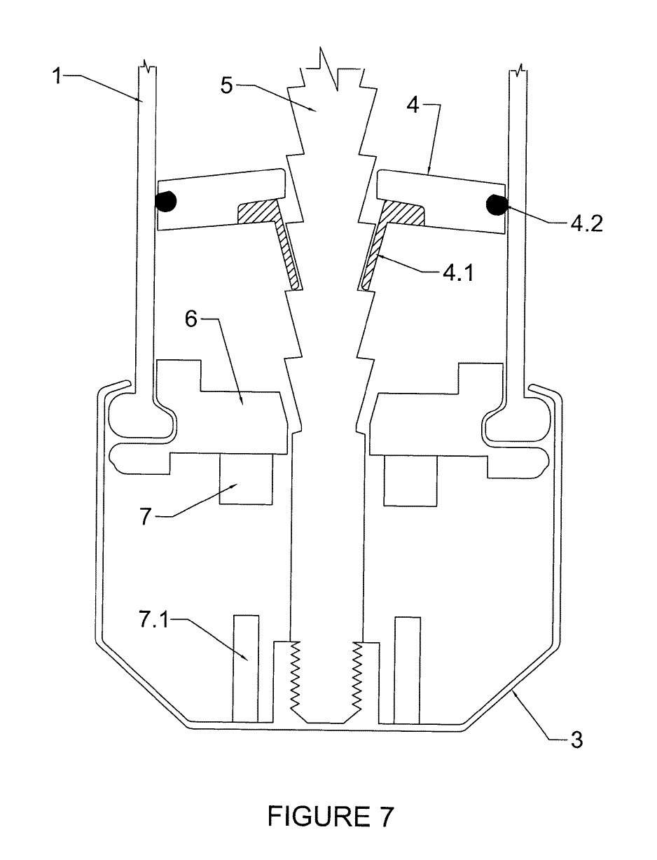

FIG. 7 is the view of the claw skip mechanism with level adjustment when the button returns to the initial position and the pusher has skipped one claw.

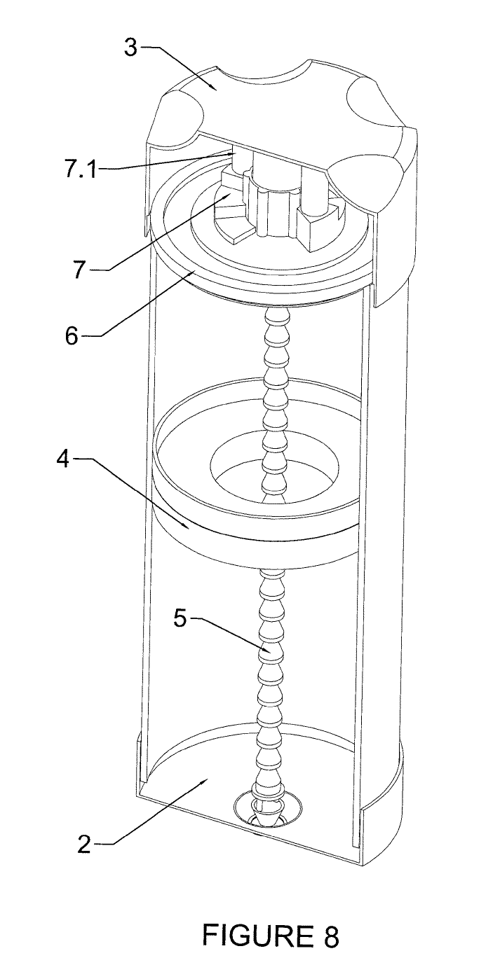

FIG. 8 is the view of the claw skip mechanism with level adjustment when the level adjustment (zero level) is in locked position.

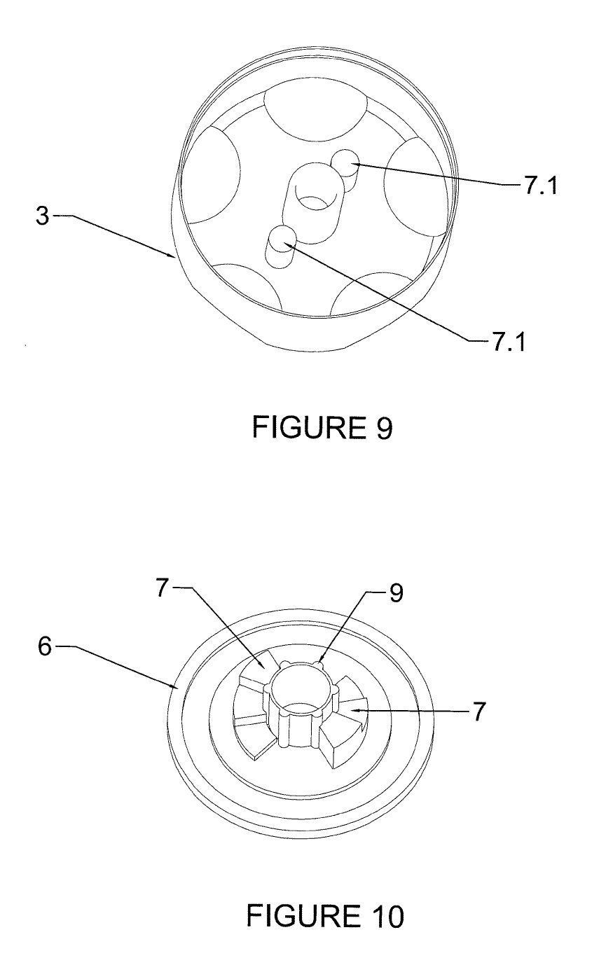

FIG. 9 is the general view of the button from inside.

FIG. 10 is the general view of the base lid and levels.

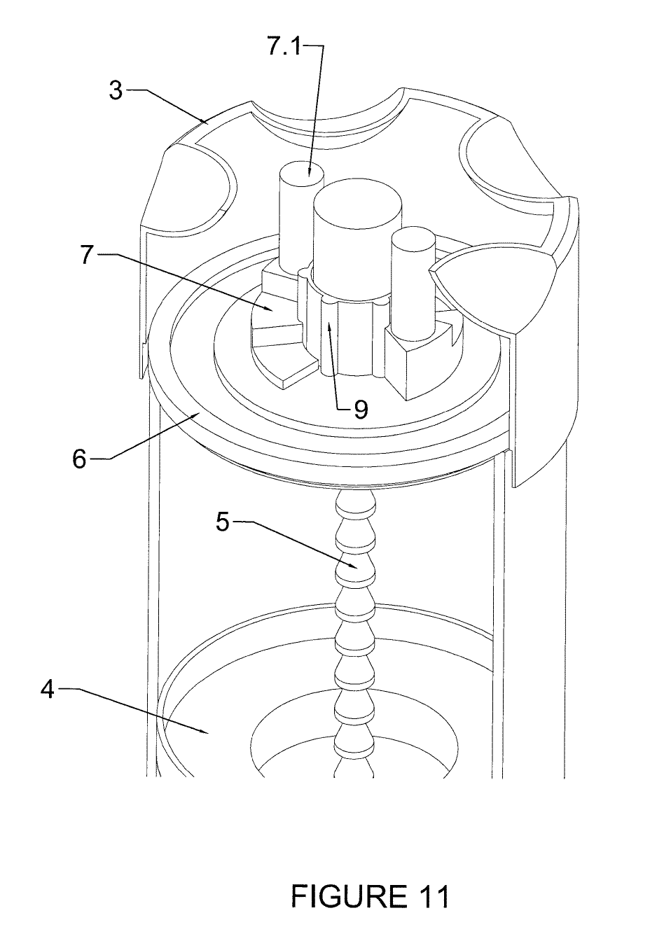

FIG. 11 is the view of the claw skip mechanism with level adjustment when the level adjustment (zero level) is in locked position (upper surface of the button wiped).

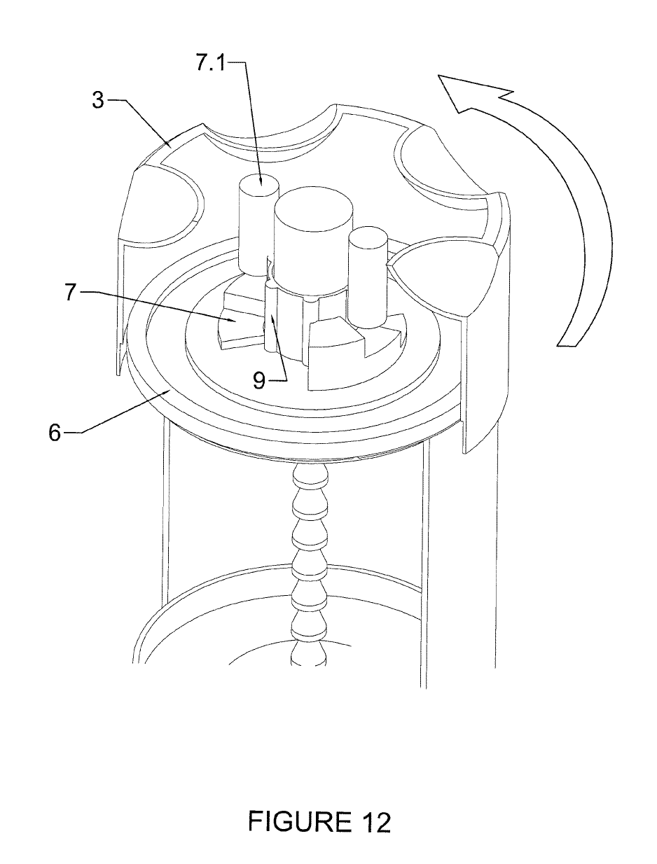

FIG. 12 is the view of the claw skip mechanism with level adjustment when the button is turned one level.

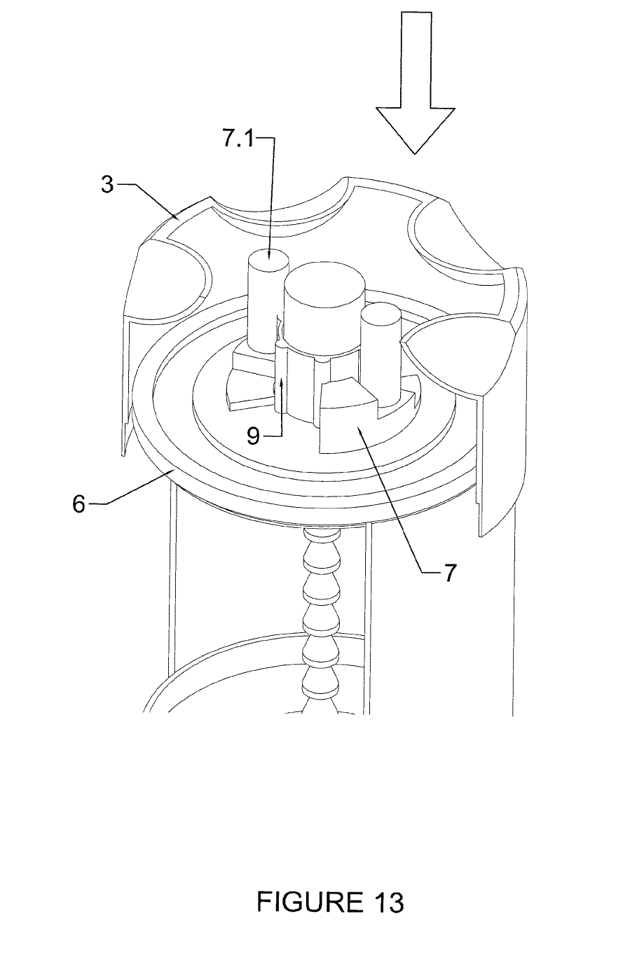

FIG. 13 is the view of the claw skip mechanism with level adjustment when the button is pressed as it is turned one level.

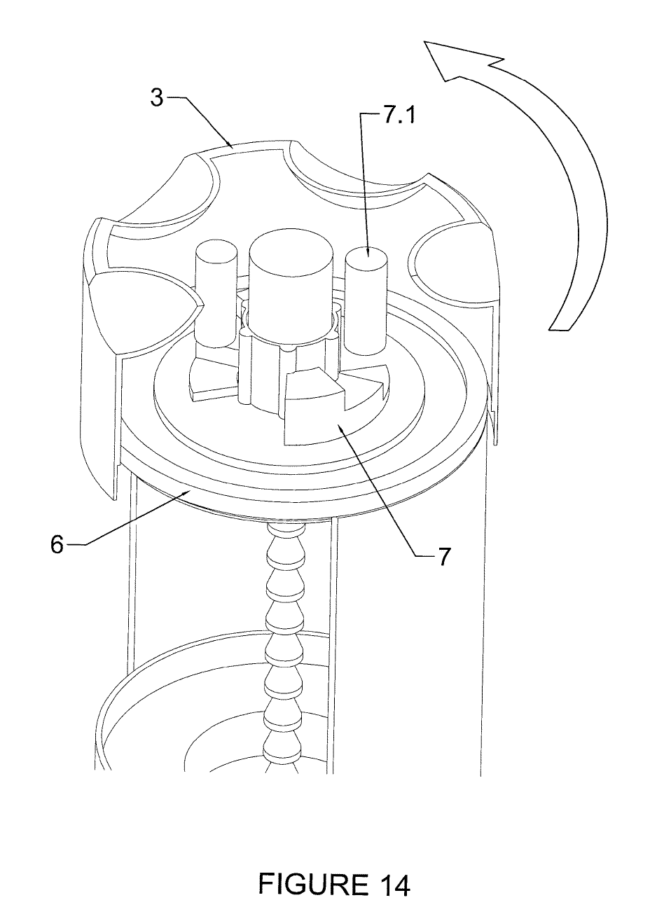

FIG. 14 is the view of the claw skip mechanism with level adjustment when the button is turned two levels.

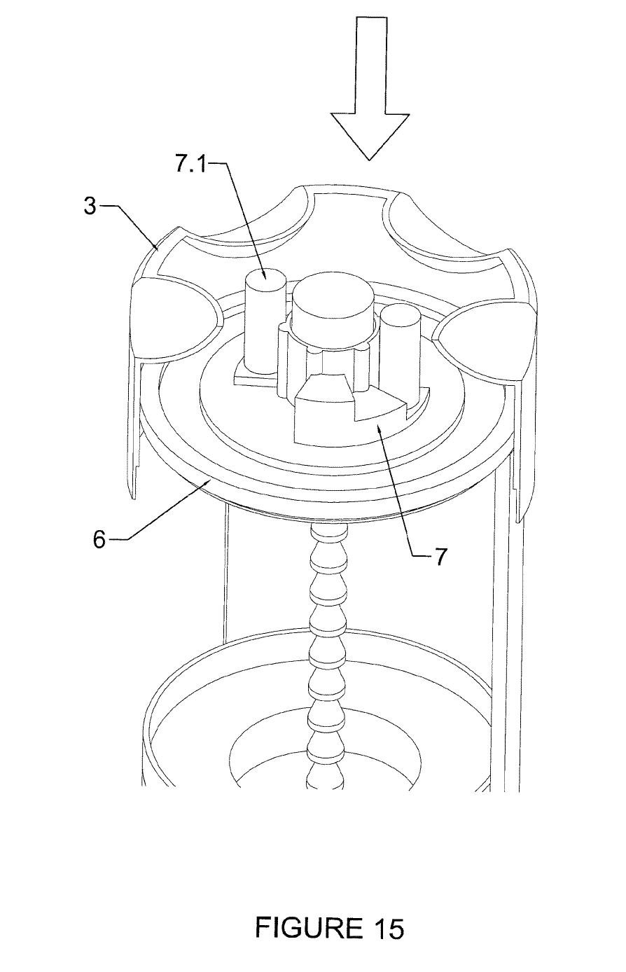

FIG. 15 is the view of the claw skip mechanism with level adjustment when the button is pressed as it is turned two levels.

Legend:

| NO | NAME OF THE PART |
|---|---|
| 1 | Package body |
| 2 | Lid |
| 2.1 | Opening |
| 3 | Button |
| 4 | Pusher |
| 4.1 | Elastic extension |
| 4.2 | Gasket |
| 5 | Stem |
| 5.1 | Claw |
| 6 | Base lid |
| 7 | Level |
| 7.1 | Counter level |
| 8 | Dispense end |
| 9 | Adjustment markers |

The present invention which relates to claw skip mechanism with level adjustment that enables the products such as ketchup, mayonnaise, honey, toothpaste, hair dye, butter etc. to be dispensed at the desired dose from the presentation containers in tube etc. form is generally characterized by; at least one stem(5) within the package body(l); sequential claws(5.1) on the stem(5); button(3) enabling the user to push the stem(5) towards the lid(2) at adjustable amounts; at least one pusher(4) which moves towards the lid(2) together with the stem(5) as the user presses the button(3) and this way which pushes the product in the package towards the opening(2.1) of the lid(2); gasket(4.2) providing the movement of the pusher(4) within the package body(l) without leaving any residues; elastic extensions(4.1) which provide the pusher(4) to grab one or more claws(5.1) and move, when the stem(5) moves towards the lid(2) and which provide the pusher(4) to skip one or more claws(5.1) by stretching outwards when the stem(5) returns to its initial position; at least two levels(7) and at least one counter level(7.1) positioned across each other on the lid(2) and the base lid(6); level(7) steps enabling the formation of the mentioned distances between the level(7) and the counter level(7.1) as the button(3) or the base lid(6) is turned; adjustability of the product amount to be dispensed from the package opening(2.1) thanks to the adjustability of the distance between the level(7) and the counter level(7.1); adjustment markers(9) enabling the levels(7) to take their places as the user turns the button(3) or the base lid(6) for level(7) adjustment.

The use of the invention as general sampling is as follows:

The button(3) is kept in locked position in order to prevent the dispensing of the product involuntarily from the package which contains honey, ketchup, mayonnaise, cream, butter, dye etc., when not in use. The button(3) cannot be pushed forward when the distance between the levels(7) and the counter level(7.1) positioned across each other on the button(3) and the base lid(6) is zero. This way, the claw(5.1) skip mechanism is in a locked position.

The user turns the button(3) or the base lid(6) towards a certain direction in order to unlock the button(3). During this turning process, the user determined the extent of such turning (level(7) adjustment amount) by means of the adjustment markers(9). The adjustment markers(9) exhibit a minor resistance against the turning movement when the user turns the button(3) or the base lid(6) to the extent that they correspond to the next level(7) step. When the user feels this resistance, he understands that a level(7) is adjusted. The user who desires to proceed to the next level(7), continues turning process until the next resistance. The level(7) adjustment markers can also be marked on the package body(l) and/or the button(3) and/or the base lid(6) as prints or reliefs or visuals.

When the user turns the button(3) or the base lid(6) to the extent to correspond to a level(7) step, a lower level(7) step corresponds to the counter level(7.1). This way, a gap forms between the counter level(7.1) and the level(7). In this case, the button(3) can be moved as much as the mentioned distance. The user can increase the distance between the counter level(7.1) and the level(7) by turning the button(3) or the base lid(6) more. This way, the user can adjust the amount of product to be dispensed out of the package. The level(7) steps can be produced as in steps or as sloped.

The user presses the button(3) once after adjusting the level(7). When the user presses the button(3) once, the button(3) moves to the extent of the distance between the level(7) and the counter level(7.1). The stem(5) mounted on the button(3) also moves as much as the mentioned distance. Accordingly, the pusher(4) grabbing a claw(5.1) on the stem(5) also moves towards the lid(2) as much as the mentioned distance. The pusher(4) moving towards the lid(2) as much as the mentioned distance pushes the product before it towards the lid(2). This way, some amount of product is dispensed outside the package body(l) from the opening(2.1) of the lid(2). The dispense end(8) provides a smooth flow of the product out of the package.

The pusher(4) grabs the claws(5.1) on the stem(5) by the elastic extensions(4.1). As an example, a claw(5.1) is in the shape of a cone, pyramid or a triangle. The wide bases of the sequential claws(5.1) face the package lid(2). The elastic extensions(4.1) grab the narrow part of the upper claw(5.1) to the wide base of the lower claw(5.1). As the stem(5) moves toward the lid(2), the pusher is moved towards the lid(2) by means of the elastic extensions(4.1) on the wide base.

The claws(5.1) in the shape of a cone or pyramid or triangle can also be positioned so that their wide bases face the button(3) as based on the operational direction of the claw skip mechanism. Subject to the position of the claws(5.1), the stem(5) moves the pusher(4) by pushing and/or pulling. In this case, the elastic extensions(4.1) are designed as based on the position of the claws(5.1)

The button(3) returns to its former position when the user presses the button(3) once and releases it. The stem(5) also returns to its former position together with the button(3). The pusher(4) remains in its position during the backward movement of the stem(5). The remaining of the pusher(4) in its position is enabled by the outward stretching of the elastic extensions(4.1). While the stem(5) moves backwards, the wide parts of the claws(5.1) stretch the elastic extensions(4.1) outwards. When the elastic extensions(4.1) stretch outwards, they cannot grab the stem(5) moving backwards. As a result, the elastic extensions(4.1) and therefore, the pusher(4) skips to the upper claw(5.1). As based on the distance the stem(5) travels back, the total number of claws(5.1) skipped by the pusher(4) can be one or more. As a result, the button(3) and the pusher(4) are ready for the next forward (pressing) movement

The pusher(4) moves within the internal surface of the package body(l) without leaving any product waste, thanks to at least one gasket(4.2) placed around the pusher(4).

1. A claw skip mechanism with level adjustment that enables the products to be dispensed at the desired dose from the presentation containers in tube form comprising:
at least one stem within the package body; sequential claws on the stem;
at least one pusher which moves towards the lid of the package together with the claws on the stem, which pushes the product in the package towards the opening of the lid;
button enabling the user to push the stem and the pusher towards the lid at adjustable amounts;
the base lid positioned across the button;
the elastic extensions which provide the stem moving towards the lid as the user presses the button to carry along the pusher towards the lid and which provide the pusher to skip one or more claws when the stem returns to its initial position;
the level adjustment mechanism which provide the adjustment of the extent of the movement of the stem and the pusher, towards the lid;
at least two levels with different heights and at least one counter level positioned across each other on the button and the base lid.

2. The claw skip mechanism with level adjustment as mentioned in claim 1 having at least one gasket providing the movement of the pusher within the package body without leaving any residues.

3. The claw skip mechanism with level adjustment as mentioned in claim 1 having at least two level steps enabling the formation of the adjustment distances between the level and the counter level as the button or the base lid is turned in a certain direction.

4. The claw skip mechanism with level adjustment as mentioned in claim 1 by having claws with shapes of a cone or pyramid or triangle.

5. The claw skip mechanism with level adjustment as mentioned in claim 1 and having adjustment markers enabling the level steps to take their places as the user turns the button or the base lid for level adjustment.

6. The claw skip mechanism with level adjustment as mentioned in claim 1 having a dispense end which provides a smooth flow of the product out of the package opening.

7. The claw skip mechanism with level adjustment as mentioned in claim 1 by having visual and/or relief marks showing the user how much should turn the button or the base lid for the level adjustment.

8. The operation and adjustment method of the claw skip mechanism with level adjustment having the process stages as;
the user turning the button or the base lid towards a certain direction in order to unlock the button and/or adjust the amount of the product to be dispensed through the package opening
the user pressing the button once;
the button moving towards the lid to the extent of the distance between the level and the counter level;
the stem, together with the button, also moving towards the lid proportionally to the distance between the level and the counter level;
the pusher which grabbed any claw on the stem thanks to the elastic extensions, moving towards the lid together with the stem;
the pusher moving towards the lid proportionally to the distance between the level and the counter level and pushing the product within the package towards the opening of the lid;
this way some amount of product being dispensed out of the opening of the package;
the button, which is pressed towards the lid, returning to its former position;
the stem returning to its former position together with the button;
the elastic extensions stretching outwards due to the wide parts of claws while the stem moves backwards;
the pusher not grabbing the stem moving backwards when the elastic extensions stretch outwards;
the pusher, which cannot grab the stem, remaining at the position it moved to;
thus, the pusher skipping one or more claws as based on the distance between the level and the counter level, when the stem returns to its former position.

9. The claw skip mechanism with level adjustment as mentioned in claim 8 wherein adjustability of the distances between the level and the counter level by turning the button or the base lid towards a certain direction.

10. The claw skip mechanism with level adjustment as mentioned in claim 8 the distance between the level and the counter level determining the distance which the button the stem and the pusher shall move towards the lid.

11. The claw skip mechanism with level adjustment as mentioned in claim 8 the button being locked when the
distance between the level and the counter level is zero.
